(19) United States
(12) Patent Application Publication
(10) Pub. No.: US 2024/0250292 A1
(43) Pub. Date: Jul. 25, 2024

(54) SULFIDE SOLID ELECTROLYTE, BATTERY, AND METHOD FOR PRODUCING SULFIDE SOLID ELECTROLYTE

(71) Applicant: TOYOTA JIDOSHA KABUSHIKI KAISHA, Toyota-shi (JP)

(72) Inventors: Masaki WATANABE, Sunto-gun (JP); Keiichi MINAMI, Tagata-gun (JP)

(73) Assignee: TOYOTA JIDOSHA KABUSHIKI KAISHA, Toyota-shi (JP)

(21) Appl. No.: 18/436,978

(22) Filed: Feb. 8, 2024

Related U.S. Application Data
(63) Continuation of application No. 17/983,497, filed on Nov. 9, 2022.

(30) Foreign Application Priority Data
Nov. 22, 2021 (JP) 2021-189316

(51) Int. Cl. H01M 10/0562; H01M 10/0525

(52) U.S. Cl. CPC H01M 10/0562; H01M 10/0525; H01M 2300/0048

(57) ABSTRACT

A main object of the present disclosure is to provide a sulfide solid electrolyte with high ion conductivity. The present disclosure achieves the object by providing a sulfide solid electrolyte including a LGPS-type crystal phase containing a Li element, a Sn element, a P element, and a S element, wherein: the sulfide solid electrolyte has a composition represented by Li4−xSn1−xPxS4, provided that 0.67<x<0.76; the sulfide solid electrolyte includes, in a 31P-NMR measurement, a first peak of which peak position is 77 ppm±1 ppm, and a second peak of which peak position is 93 ppm±1 ppm; and when S1 designates a total area of all peaks obtained in the 31P-NMR measurement, and S2 designates a total area of the first peak and the second peak, a rate of S2 with respect to S1, which is S2/S1 is 92.0% or more.

This is a Continuation of application Ser. No. 17/983,497 filed Nov. 9, 2022, which claims the benefit of Japanese Patent Application No. 2021-189316 filed Nov. 22, 2021. The disclosure of the prior applications is hereby incorporated by reference herein in its entirety.

### TECHNICAL FIELD

The present disclosure relates to a sulfide solid electrolyte.

### BACKGROUND ART

An all solid state battery is a battery including a solid electrolyte layer between a cathode layer and an anode layer, and one of the advantages thereof is that the simplification of a safety device may be more easily achieved compared to a liquid-based battery including a liquid electrolyte containing a flammable organic solvent. As a solid electrolyte used for an all solid state battery, sulfide solid electrolytes have been known.

For example, Patent Literature 1 discloses a sulfide solid electrolyte containing a M₁ element (such as Li), a M₂ element (such as Ge and P), and a S element, wherein the sulfide solid electrolyte has a peak in the specified position in an X-ray diffraction measurement. Also, Patent Literature 2 discloses a sulfide solid electrolyte containing a M₁ element (such as Li), a M₂ element (such as Sn and P), and a S element, wherein the sulfide solid electrolyte has a peak in the specified position in an X-ray diffraction measurement.

### CITATION LIST

### Patent Literatures

Patent Literature 1: Japanese Patent Publication (JP-B) No. 5527673
Patent Literature 2: International Application Publication: WO 2013/118722

### SUMMARY OF DISCLOSURE

### Technical Problem

The sulfide solid electrolytes disclosed in Patent Literatures 1 and 2 include so-called LGPS-type crystal phase. Also, for example, Patent Literature 2 discloses a sulfide solid electrolyte with the composition represented by Li₄₋ₓSn₁₋ₓPₓS₄ and includes a crystal phase A (LGPS-type crystal phase), in Examples 5-1 to 5-8. In particular, in paragraph in Patent Literature 2, it is disclosed that the sulfide solid electrolytes obtained in Examples 5-3 to 5-8 included the crystal phase A (LGPS-type crystal phase), but did not include the crystal phase B (crystal phase of which ion conductivity is lower than that of the LGPS-type crystal phase).

In the XRD chart illustrated in FIGS. 12C to 12H in Patent Literature 2, since all peaks appear at the same positions, it can be determined that the sulfide solid electrolytes obtained in Examples 5-3 to 5-8 included the crystal phase A (LGPS-type crystal phase) as a single phase. Inventors of the present disclosure have produced a plurality of the sulfide solid electrolytes determined to include the crystal phase A as a single phase as described above, and newly obtained a knowledge that their ion conductivity varied. Then, the inventors further analyzed the structures of these sulfide solid electrolytes, and obtained a knowledge that these sulfide solid electrolytes contained impurity components to a small degree, and the impurity components affected the ion conductivity.

The present disclosure has been made in view of the above circumstances, and a main object thereof is to provide a sulfide solid electrolyte with high ion conductivity.

### Solution to Problem

The present disclosure provides a sulfide solid electrolyte including a LGPS-type crystal phase containing a Li element, a Sn element, a P element, and a S element, wherein: the sulfide solid electrolyte has a composition represented by Li₄₋ₓSn₁₋ₓPₓS₄, provided that 0.67<x<0.76; the sulfide solid electrolyte includes, in a ³¹P-NMR measurement, a first peak of which peak position is 77 ppm±1 ppm, and a second peak of which peak position is 93 ppm±1 ppm; and when S₁ designates a total area of all peaks obtained in the ³¹P-NMR measurement, and S₂ designates a total area of the first peak and the second peak, a rate of S₂ with respect to S₁, which is S₂/S₁ is 92.0% or more. According to the present disclosure, the S₂/S₁ is large, and thus the sulfide solid electrolyte with high ion conductivity may be achieved.

In the disclosure, the sulfide solid electrolyte may include at least one of a third peak of which peak position is 87 ppm±1 ppm, and a fourth peak of which peak position is 89 ppm±1 ppm, in a ³¹P-NMR measurement; and when S₁ designates a total area of all peaks obtained in the ³¹P-NMR measurement, and S₃ designates a total area of the third peak and the fourth peak, a rate of S₃ with respect to S₁, which is S₃/S₁ may be 6.0% or less.

In the disclosure, the sulfide solid electrolyte may include a fifth peak of which peak position is 68 ppm±1 ppm in a ³¹P-NMR measurement; and when S₁ designates an area of all peaks obtained in the ³¹P-NMR measurement, and S₄ designates an area of the fifth peak, a rate of S₄ with respect to S₁, which is S₄/S₁ may be 0.5% or less.

In the disclosure, the S₂/S₁ may be 95.0% or more.

In the disclosure, the x may satisfy 0.67<x≤0.74.

In the disclosure, the x may satisfy 0.67<x≤0.72.

In the disclosure, an ion conductivity of the sulfide solid electrolyte at 25° C. may be 5.25 mS/cm or more.

The present disclosure also provides a battery including a cathode layer containing a cathode active material, an anode layer containing an anode active material, and an electrolyte layer arranged between the cathode layer and the anode layer, wherein: at least one of the cathode layer, the anode layer, and the electrolyte layer contains the above described sulfide solid electrolyte.

According to the present disclosure, usage of the above described sulfide solid electrolyte allows a battery to have excellent discharge properties.

The present disclosure also provides a method for producing a sulfide solid electrolyte including a LGPS-type crystal phase containing a Li element, a Sn element, a P element, and a S element, the method comprising: an amorphizing step of amorphizing a raw material composition to obtain an ion conductive material; and a heating step of heating the ion conductive material in an inert gas flow to obtain the sulfide solid electrolyte; wherein: the sulfide solid electrolyte includes, in a ³¹P-NMR measurement, as peaks of the LGPS-type crystal phase, a first peak of which peak position is 77 ppm±1 ppm, and a second peak of which peak position is 93 ppm±1 ppm; and when S₁ designates a total area of all peaks obtained in the ³¹P-NMR measurement, and S₂ designates a total area of the first peak and the second peak, a rate of S₂ with respect to S₁, which is S₂/S₁ is 92.0% or more.

According to the present disclosure, heating is performed in the inert gas flow, and thus the sulfide solid electrolyte with large S₂/S₁ and high ion conductivity may be obtained.

### Advantageous Effects of Disclosure

The present disclosure exhibits an effect of providing a sulfide solid electrolyte with high ion conductivity.

### BRIEF DESCRIPTION OF DRAWINGS

FIGS. 1A and 1B are explanatory diagrams explaining the peak separation of the NMR chart in the present disclosure.

FIG. 2 is a perspective view exemplifying the LSnPS crystal phase in the present disclosure.

FIG. 3 is a schematic cross-sectional view exemplifying the battery in the present disclosure.

FIG. 4 is a flow chart exemplifying the method for producing the sulfide solid electrolyte in the present disclosure.

FIG. 5 is the result of XRD measurements for the sulfide solid electrolytes obtained in Examples 1 to 6 and Comparative Examples 1 to 5.

FIG. 6 is the result of ³¹P-NMR measurements for the sulfide solid electrolytes obtained in Examples 1 to 6 and Comparative Examples 1 to 5.

FIG. 7 is a graph showing the relation of the S₂/S₁ and the ion conductivity regarding the sulfide solid electrolytes obtained in Examples 1 to 6 and Comparative Examples 1 to 5.

FIG. 8 is an enlarged view of a part of FIG. 7.

### DESCRIPTION OF EMBODIMENTS

The sulfide solid electrolyte, the battery, and the method for producing the sulfide solid electrolyte in the present disclosure will be hereinafter explained in details. In the present disclosure, a LGPS-type crystal phase containing a Li element, a Sn element, a P element, and a S element may be referred to as a LSnPS crystal phase.

### A. Sulfide Solid Electrolyte

The sulfide solid electrolyte in the present disclosure is a sulfide solid electrolyte including a LGPS-type crystal phase containing a Li element, a Sn element, a P element, and a S element, wherein: the sulfide solid electrolyte has a composition represented by Li₄₋ₓSn₁₋ₓPₓS₄, provided that 0.67<x<0.76; the sulfide solid electrolyte includes, in a ³¹P-NMR measurement, a first peak of which peak position is 77 ppm±1 ppm, and a second peak of which peak position is 93 ppm±1 ppm; and when S₁ designates a total area of all peaks obtained in the ³¹P-NMR measurement, and S₂ designates a total area of the first peak and the second peak, a rate of S₂ with respect to S₁, which is S₂/S₁ is 92.0% or more.

According to the present disclosure, the S₂/S₁ is large, and thus the sulfide solid electrolyte with high ion conductivity may be achieved. As described above, Patent Literature 2 discloses a sulfide solid electrolyte determined to be a single phase material of the LGPS-type crystal phase, based on an XRD measurement. The inventors of the present disclosure have analyzed the structures of such a sulfide solid electrolyte in details. In specific, the state of P (phosphorus) in the sulfide solid electrolyte was analyzed by a ³¹P-NMR measurement. As a result, the inventors have obtained a knowledge that the sulfide solid electrolyte determined to be the single phase material contained impurity components to a small degree. It has been presumed that, as described in Examples later, the impurity components were Li₃PS₄ and Li₃PS₂O₂. The Li₃PS₂O₂ is presumably a compound produced by a reaction of the elements included in the raw material composition with oxygen elements inevitably mixed therein.

After obtaining the knowledge, the inventors of the present disclosure have tried to reduce the ratio of the impurity components. However, as described in Patent Literature 2, even when an amorphized ion conductive material was heated in a sealed tube, reduction of the ratio of the impurity components, that was, improvement of the ratio of the LGPS-type crystal phase, was difficult. The inventors of the present disclosure have pursued earnest studies, and as a result, obtained a desired sulfide solid electrolyte by heating the amorphized ion conductive material in an inert gas flow, while considering the impurity components as a control value.

The sulfide solid electrolyte in the present disclosure includes, in a ³¹P-NMR measurement, a first peak of which peak position is 77 ppm±1 ppm, and a second peak of which peak position is 93 ppm±1 ppm. Both of the first peak and the second peak correspond to the peak of PS₄ in the LSnPS crystal phase.

The sulfide solid electrolyte in the present disclosure may include, in a ³¹P-NMR measurement, at least one of a third peak of which peak position is 87 ppm±1 ppm, and a fourth peak of which peak position is 89 ppm±1 ppm. Both of the third peak and the fourth peak correspond to the peak of PS₄ in a phase (probably Li₃PS₄) other than the LSnPS crystal phase. The sulfide solid electrolyte may or may not include the third peak. Also, the sulfide solid electrolyte may or may not include the fourth peak.

The sulfide solid electrolyte in the present disclosure may include, in a ³¹P-NMR measurement, a fifth peak of which peak position is 68 ppm±1 ppm. The fifth peak corresponds to the peak of an anion part (probably PS₂O₂) in a phase (probably Li₃PS₂O₂) containing Li, P, S, and O.

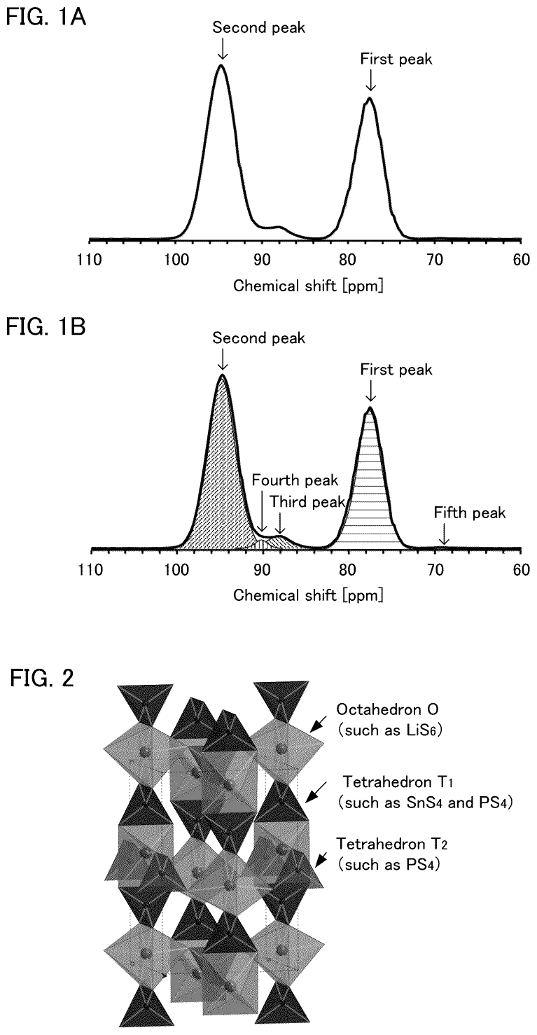

In the present disclosure, peak separation is performed to the NMR chart obtained in the ³¹P-NMR measurement. On this occasion, fitting is performed to minimize the accidental error. FIGS. 1A and 1B are explanatory diagrams explaining the peak separation of the NMR chart in the present disclosure. For example, the NMR chart as shown in FIG. 1A is obtained by performing a ³¹P-NMR measurement to the sulfide solid electrolyte in the present disclosure. In FIG. 1A, the above described first peak and second peak are observed as large peaks. Further, when the peak separation is performed to the NMR chart shown in FIG. 1A considering each peak described above, each peak is identified as shown in FIG. 1B.

Here, S₁ designates a total area of all peaks obtained in the ³¹P-NMR measurement. Also, S₂ designates a total area of the first peak and the second peak, S₃ designates the total area of the third peak and the fourth peak, and S₄ designates the area of the fifth peak.

The rate of S₂ with respect to S₁, which is S₂/S₁ is preferably much. The reason therefor is to obtain a sulfide solid electrolyte with high ratio of the LGPS-type crystal phase. The S₂/S₁ is usually 92.0% or more, may be 93.0% or more, may be 94.0% or more, and may be 95.0% or more. Also, the rate of S₃ with respect to S₁, which is S₃/S₁ is preferably little. The reason therefor is to obtain a sulfide solid electrolyte with low ratio of the impurity components. The S₃/S₁ is, for example, 7.5% or less, may be 7.0% or less, may be 6.5% or less, may be 6.0% or less, and may be 3.5% or less. Also, the rate of S₄ with respect to S₁, which is S₄/S₁ is preferably little. The reason therefor is to obtain a sulfide solid electrolyte with low ratio of the impurity components. The S₄/S₁ is, for example, 0.5% or less and may be 0.4% or less. Similarly, the rate of S₄ with respect to S₂, which is S₄/S₂ is preferably little. The reason therefor is to obtain a sulfide solid electrolyte with low ratio of the impurity components. The S₄/S₂ is, for example, 0.5% or less and may be 0.4% or less.

The sulfide solid electrolyte in the present disclosure comprises a LGPS-type crystal phase (LSnPS crystal phase) containing a Li element, a Sn element, a P element, and a S element. FIG. 2 is a perspective view exemplifying the LSnPS crystal phase in the present disclosure. The LSnPS crystal phase shown in FIG. 2 includes an octahedron O configured by a Li element and a S element, a tetrahedron T₁ configured by a Ma element and a S element, and a tetrahedron T₂ configured by a Mb element and a S element. The tetrahedron T₁ and the octahedron O share the edge, and the tetrahedron T₂ and the octahedron O share the top. At least one of the Mₐ element and the M_{b} element includes a Sn element. Similarly, at least one of the Mₐ element and the M_{b} element includes a P element. The space group of the LSnPS crystal phase is typically categorized as P4₂/nmc (137).

In the LSnPS crystal phase in the present disclosure, peaks are observed in the specific positions in an X-ray diffraction measurement using a CuKα ray. Examples of the peak positions of the LSnPS crystal phase may include, 2θ=17.38°, 20.18°, 20.44°, 23.56°, 23.96°, 24.93°, 26.96°, 29.07°, 29.58°, 31.71°, 32.66°, and 33.39°. In particular, the LSnPS crystal phase includes characteristic peaks in the positions of 2θ=20.18°, 20.44°, 26.96°, and 29.58°. Also, the peak positions may be slightly shifted when a crystal lattice slightly changes due to factors such as a material composition. For this reason, each of these peak positions may shift in the range of ±0.50°, may shift in the range of ±0.30°, and may shift in the range of ±0.10°.

The sulfide solid electrolyte in the present disclosure has a composition represented by Li₄₋ₓSn₁₋ₓPₓS₄, provided that 0.67<x<0.76. Here, Li₄₋ₓSn₁₋ₓPₓS₄ corresponds to a composition that is a tie line of Li₄SnS₄ and xLi₃PS₄. In other words, Li₄₋ₓSn₁₋ₓPₓS₄ is compositionally equivalent to (1−x)Li₄SnS₄-xLi₃PS₄. Also, when it is defined as y=x/(1−x), Li₄₋ₓSn₁₋ₓPₓS₄ is compositionally equivalent to Li₄SnS_{4-y}Li₃PS₄. Incidentally, Li₄SnS₄ is compositionally equivalent to 2Li₂S−1SnS₂, and Li₃PS₄ is compositionally equivalent to 3Li₂S−1P₂S₅.

The “x” in Li₄₋ₓSn₁₋ₓPₓS₄ is usually larger than 0.67 (=⅔). “x=0.67 (y=2)” corresponds to a stoichiometric composition of the LSnPS crystal phase in the present disclosure. When “y” in Li₄SnS_{4-y}Li₃PS₄ is larger than 2, it is a composition where Li₃PS₄ is easily generated as the impurity components. Even in such a composition, the S₂/S₁ may be increased by, for example, adopting the production method described later. The “x” may be 0.68 or more, may be 0.69 or more, may be 0.70 or more, and may be 0.71 or more. Meanwhile, the “x” is, for example, less than 0.76, may be 0.74 or less, and may be 0.72 or less. Also, the range of the “x” may be a range excluding 0.73 (that is 0.725 or more and 0.734 or less).

The Li ion conductivity of the sulfide solid electrolyte in the present disclosure is preferably high. The ion conductivity of the sulfide solid electrolyte at 25° C. is, for example, 5.0 mS/cm or more, 5.25 mS/cm or more, and may be 5.3 mS/cm or more. The ion conductivity may be obtained by A.C. impedance method. Also, examples of the shape of the sulfide solid electrolyte may include a granular shape. The average particle size (D₅₀) of the sulfide solid electrolyte is, for example, 0.1 μm or more and 50 μm or less. Also, the sulfide solid electrolyte may be used for arbitrary applications requiring the ion conductivity. Above all, the sulfide solid electrolyte is preferably used for a battery.

### B. Battery

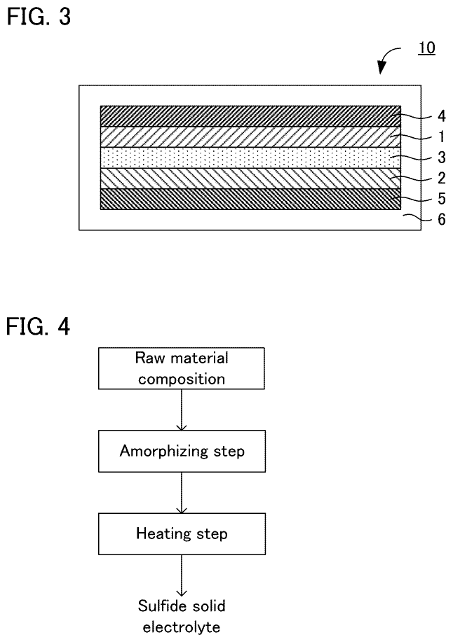

FIG. 3 is a schematic cross-sectional view exemplifying the battery in the present disclosure. Battery 10 in FIG. 3 includes cathode layer 1 containing a cathode active material, anode layer 2 containing an anode active material, electrolyte layer 3 arranged between the cathode layer 1 and the anode layer 2, cathode current collector 4 for collecting currents of the cathode layer 1, anode current collector 5 for collecting currents of the anode layer 2, and outer package 6 for storing these members. In the present disclosure, at least one of the cathode layer 1, the anode layer 2, and the electrolyte layer 3 contains the sulfide solid electrolyte described in “A. Sulfide solid electrolyte” above.

According to the present disclosure, the above described sulfide solid electrolyte is used, and thus a battery with excellent discharge properties may be achieved.

### 1. Cathode Layer

The cathode layer in the present disclosure contains at least a cathode active material. The cathode layer may contain at least one of a solid electrolyte, a conductive material, and a binder. In particular, the cathode layer preferably contains the above described sulfide solid electrolyte as the solid electrolyte. The proportion of the sulfide solid electrolyte in the cathode layer is, for example, 5 volume % or more, may be 10 volume % or more, and may be 20 volume % or more. Meanwhile, the proportion of the sulfide solid electrolyte in the cathode layer is, for example, 60 volume % or less.

Examples of the cathode active material may include a rock salt bed type active material such as LiCoO₂, LiMnO₂, LiNiO₂, LiVO₂, and LiNi_{1/3}Co_{1/3}Mn_{1/3}O₂; a spinel type active material such as LiMn₂O₄, Li₄Ti₅O₁₂, and Li (Ni_{0.5}Mn_{1.5})O₄; and an olivine type active material such as LiFePO₄, LiMnPO₄, LiNiPO₄, and LiCoPO₄. The surface of the cathode active material may be coated with a Li-ion conductive oxide such as LiNbO₃. The thickness of the Li-ion conductive oxide is, for example, 1 nm or more and 30 nm or less.

Examples of the conductive material may include a particulate carbon material such as acetylene black (AB) and Ketjen black (KB); and a fiber carbon material such as carbon fiber, carbon fiber nanotube (CNT), and carbon nanofiber (CNF). Examples of the binder may include a fluorine-based binder such as polyvinylidene fluoride (PVDF). The thickness of the cathode layer is, for example, 0.1 μm or more and 1000 μm or less.

### 2. Anode Layer

The anode layer in the present disclosure contains at least an anode active material. The anode layer may contain at least one of a solid electrolyte, a conductive material, and a binder. In particular, the anode layer preferably contains the above described sulfide solid electrolyte as the solid electrolyte. The proportion of the sulfide solid electrolyte in the anode layer is, for example, 5 volume % or more, may be 10 volume % or more, and may be 20 volume % or more. Meanwhile, the proportion of the sulfide solid electrolyte in the anode layer is, for example, 60 volume % or less.

Examples of the anode active material may include a Li-based active material such as a metal lithium and a lithium alloy; a carbon-based active material such as graphite and hard carbon; an oxide-based active material such as lithium titanate; and a Si-based active material such as a simple substance of S₁, a S₁ alloy and a silicon oxide. Also, the conductive material and the binder to be used in the anode layer are the same as the materials used in the cathode layer described above. The thickness of the anode layer is, for example, 0.1 μm or more and 1000 μm or less.

### 3. Electrolyte Layer

The electrolyte layer in the present disclosure is arranged between the cathode layer and the anode layer, and contains an electrolyte. The electrolyte used in the electrolyte layer may be a solid electrolyte and may be an electrolyte solution. Among those, the electrolyte layer is preferably a solid electrolyte layer containing a solid electrolyte. Incidentally, a battery including the solid electrolyte layer is also called an all solid state battery. The solid electrolyte layer preferably contains the above described sulfide solid electrolyte. The proportion of the sulfide solid electrolyte in the solid electrolyte layer is, for example, 50 volume % or more, may be 70 volume % or more, and may be 90 volume % or more. The thickness of the electrolyte layer is, for example, 0.1 μm or more and 1000 μm or less.

### 4. Battery

The battery in the present disclosure may include a cathode current collector and an anode current collector. Examples of the material for the cathode current collector may include SUS, aluminum, nickel, iron, titanium, and carbon. Meanwhile, examples of the material for the anode current collector may include SUS, copper, nickel, and carbon. Examples of the outer package may include a laminate type outer package and a case type outer package.

The battery in the present disclosure is typically a lithium ion secondary battery. The application of the battery is not particularly limited, and examples thereof may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably used as a power source for driving hybrid electric vehicles, plug-in hybrid electric vehicles, or battery electric vehicles. Also, the all solid state battery in the present disclosure may be used as a power source for moving bodies other than vehicles (such as rail road transportation, vessel and airplane), and may be used as a power source for electronic products such as information processing equipment.

### C. Method for Producing Sulfide Solid Electrolyte

FIG. 4 is a flow-chart exemplifying the method for producing the sulfide solid electrolyte in the present disclosure. In FIG. 4, first, Li₂S, P₂S₅, and SnS₂ are mixed to prepare a raw material composition. Next, the raw material composition is amorphized by, for example, ball milling to obtain an ion conductive material (amorphizing step). Next, the obtained ion conductive material is heated in an inert gas flow (heating step). Thereby, a sulfide solid electrolyte is obtained. In the obtained sulfide solid electrolyte, the S₂/S₁ is the specified value or more.

According to the present disclosure, heating is performed in an inert gas flow, and thus the sulfide solid electrolyte with large S₂/S₁ is obtained.

### 1. Amorphizing Step

The amorphizing step in the present disclosure is a step of amorphizing a raw material composition to obtain an ion conductive material.

The raw material composition contains a Li element, a Sn element, a P element, and a S element. The raw material composition is preferably a mixture containing a Li source, a Sn source, a P source, and a S source. Examples of the Li source may include a sulfide containing Li. Examples of the sulfide containing Li may include Li₂S. Examples of the Sn source may include a simple substance Sn, and a sulfide containing Sn. Examples of the sulfide containing Sn may include SnS₂. Examples of the P source may include a simple substance P, and a sulfide containing P. Examples of the sulfide containing P may include P₂S₅. Examples of the S source may include a simple substance S, a sulfide containing Li, a sulfide containing Sn, and a sulfide containing P.

The raw material composition may have, for example, a composition represented by Li_{4-z}Sn_{1-z}P_{z}S₄ (0.67<z<0.76). The “z” may be 0.68 or more, may be 0.69 or more, may be 0.70 or more, and may be 0.71 or more. Meanwhile, the “z” may be 0.74 or less, and may be 0.72 or less.

The method for amorphizing the raw material composition is not particularly limited, and examples thereof may include a mechanical milling method and melting and quenching method. In the mechanical milling method, the raw material composition is crushed while applying mechanical energy. Examples of the mechanical milling may include ball milling, vibration milling, turbo milling, and disc milling. Conditions of the amorphizing are appropriately arranged so as to obtain the desired ion conductive material.

When planetary ball milling is performed, the weighing table revolving speed is, for example, 200 rpm or more and 600 rpm or less, and 300 rpm or more and 500 rpm or less. The treatment time of the planetary ball milling is, for example, 1 hour or more and 100 hours or less, and may be 5 hours or more and 70 hours or less. Also, when the vibration milling is performed, the vibration amplitude is, for example, 5 mm or more and 15 mm or less, and may be 6 mm or more and 10 mm or less. The vibration frequency of the vibration milling is, for example, 500 rpm or more and 2000 rpm or less, and may be 1000 rpm or more and 1800 rpm or less. Also, it is preferable to use a vibrator (such as vibrator made of alumina) for the vibration milling. The treatment time of the vibration milling is, for example, 1 hour or more and 100 hours or less, and may be 5 hours or more and 70 hours or less.

The crystallinity of the raw material in the ion conductive material is usually lower than the crystallinity of the raw material in the raw material composition. The crystallinity of the raw material may be confirmed by an X-ray diffraction (XRD) measurement. For example, when the raw material composition contains Li₂S as the raw material, the ion conductive material may or may not include a peak of Li₂S in the XRD measurement. In the former case, the peak intensity of Li₂S in the ion conductive material is usually smaller than the peak intensity of Li₂S in the raw material composition.

### 2. Heating Step

The heating step in the present disclosure is a step of heating the ion conductive material in an inert gas flow to obtain the sulfide solid electrolyte.

Examples of the inert gas may include a noble gas such as argon and helium. Incidentally, an additional gas may be included in the inert gas as long as the desired sulfide solid electrolyte is obtained. Also, the flow amount of the inert gas is not particularly limited, and is appropriately set so as to obtain the desired sulfide solid electrolyte.

The heating conditions for the heating treatment are also appropriately set so as to obtain the desired sulfide solid electrolyte. The heating temperature is, for example, 300° C. or more, may be 400° C. or more, and may be 500° ° C. or more. Meanwhile, the heating temperature is, for example, 1000° C. or less and may be 700° C. or less. Also, the heating time is appropriately set so as to obtain the desired sulfide solid electrolyte.

### 3. Sulfide Solid Electrolyte

In the sulfide solid electrolyte obtained by the above described amorphizing step and heating step, the S₂/S₁ is the specified value or more. There are no particular limitations on the composition of the sulfide solid electrolyte. Preferable embodiments of the sulfide solid electrolyte are in the same contents as those described in “A. Sulfide solid electrolyte” above.

The present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

In Examples and Comparative Examples below, all operations were performed in a manner such that materials did not contact atmospheric air so as to prevent oxidation and deterioration of the materials.

### Example 1

As starting materials, a lithium sulfide (Li₂S, from Nippon Chemical Industrial Co., Ltd.), phosphorous pentasulfide (P₂S₅, from Aldrich), and a tin sulfide (SnS₂, from Kojundo Chemical Laboratory Co., Ltd.) were used. Powder of these were weighed so as to be Li₄₋ₓSn₁₋ₓPₓS₄ in which x=0.70, in a glove box under an argon atmosphere, and mixed by an agate mortar. Thereby, a raw material composition was obtained.

Next, the obtained raw material composition and crushing balls (zirconium balls) were projected into a container (zirconium pot) in a glove box under an argon atmosphere, and the container was sealed. On this occasion, the volume of the crushing balls added was adjusted to approximately ⅙ of the volume of the container, and the weight of the raw material composition added was adjusted to approximately 1/50 of the weight of the crushing balls. This container was installed to a planetary ball milling machine (P7 from Fritsch), and mechanical milling was conducted at the weighing table revolving speed of 370 rpm for 40 hours. Thereby, an ion conductive material was obtained.

Next, the obtained ion conductive material was arranged on a graphite board, and heated in an Ar gas flow. The heating conditions were as follows. That was, the temperature was raised from the room temperature to 570° C. at the temperature raising speed of 1.1° C./minute, 570° ° C. was maintained for 20 hours, and then cooled to the room temperature. Thereby, the sulfide solid electrolyte with a composition represented by Li₄₋ₓSn₁₋ₓPₓS₄, in which x=0.7 was obtained.

### Examples 2 to 6

A sulfide solid electrolyte was respectively obtained in the same manner as in Example 1, except that the composition of the raw material composition and the heating temperature were changed to the contents shown in Table 1.

### Comparative Example 1

An ion conductive material was obtained in the same manner as in Example 1, except that the composition of the raw material composition was changed to Li₄₋ₓSn₁₋ₓPₓS₄, in which x=0.64. The obtained ion conductive material was vacuum-sealed in a carbon-coated quartz tube. The pressure of the vacuum-sealed quartz tube was approximately 30 Pa. Next, the quartz tube was placed in a burning furnace, and the temperature was raised from the room temperature to 500° C. over 6 hours, 500° C. was maintained for 8 hours, and then cooled to the room temperature. Thereby, the sulfide solid electrolyte with a composition represented by Li₄₋ₓSn₁₋ₓPₓS₄, in which x=0.64 was obtained.

### Comparative Examples 2 to 4

A sulfide solid electrolyte was respectively obtained in the same manner as in Comparative Example 1, except that the composition of the raw material composition was changed to the contents shown in Table 1.

### Comparative Example 5

A sulfide solid electrolyte was obtained in the same manner as in Example 1, except that the composition of the raw material composition and the heating temperature were changed to the contents shown in Table 1.

TABLE 1

| | | | | Heating |
|---|---|---|---|---|
| | Li₄₋ₓSn₁₋ₓPₓS₄ | | | temp. |
| | x | y = x/(1-x) | Heating method | (° C.) |
| Example 1 | 0.70 | 2.3 | in Ar gas flow | 570 |
| Example 2 | 0.71 | 2.5 | in Ar gas flow | 550 |
| Example 3 | 0.72 | 2.6 | in Ar gas flow | 550 |
| Example 4 | 0.72 | 2.6 | in Ar gas flow | 530 |
| Example 5 | 0.72 | 2.6 | in Ar gas flow | 510 |
| Example 6 | 0.74 | 2.8 | in Ar gas flow | 550 |
| Comp. Ex. 1 | 0.64 | 1.8 | in sealed tube | 500 |
| Comp. Ex. 2 | 0.67 | 2.0 | in sealed tube | 500 |
| Comp. Ex. 3 | 0.72 | 2.6 | in sealed tube | 500 |
| Comp. Ex. 4 | 0.75 | 3.0 | in sealed tube | 500 |
| Comp. Ex. 5 | 0.76 | 3.2 | in Ar gas flow | 550 |

### <X-Ray Diffraction Measurement>

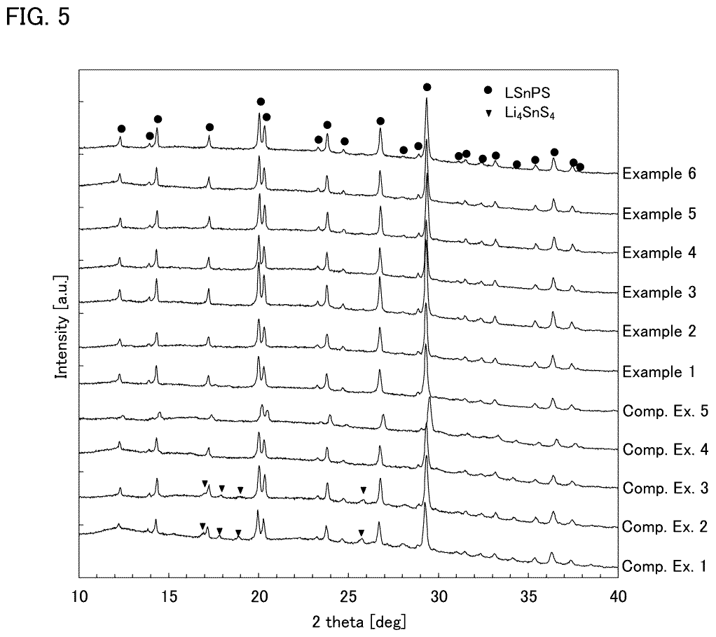

An X-ray diffraction (XRD) measurement was respectively conducted to the sulfide solid electrolytes obtained in Examples 1 to 6 and Comparative Examples 1 to 5. The XRD measurement was conducted to the powder sample in the conditions of, under inert atmosphere and usage of a CuKα ray. The results are shown in FIG. 5. As shown in FIG. 5, it was confirmed that all the sulfide solid electrolytes obtained in Examples 1 to 6 and Comparative Examples 1 to 5 had the LSnPS crystal phase (LGPS-type crystal phase containing a Li element, a Sn element, a P element and a S element).

Also, in Comparative Examples 1 and 2, peaks of Li₄SnS₄ crystal phase were confirmed other than the peaks of the LSnPS crystal phase. In contrast, in Examples 1 to 6 and in Comparative Examples 3 to 5, the peaks of Li₄SnS₄ crystal phase were not confirmed, and it was suggested that they were the materials including the LSnPS crystal phase as a single phase.

### <³¹P-NMR Measurement>

The ³¹P-NMR measurement was respectively conducted to the sulfide solid state electrolytes obtained in Examples 1 to 6 and Comparative Examples 1 to 5. The ³¹P-NMR measurement was conducted in the following conditions.
Device: AVANCE400 from Bruker
Measurement method: single pulse method
Measurement nuclear frequency: 161.9810825 MHZ (³¹P nuclear)
Spectral width: 100.0 KHz
Pulse width: 1.5 μsec (45° pulse)
Pulse repeating time ACQTM: 0.0410150 sec, pd=3000 sec
Numbers of observation points: 8192
Reference substance: diammonium hydrogenphosphate (external reference: 1.33 ppm)
Room temperature: approximately 25° C.
Sample revolving number: 9.5, 15 kHz

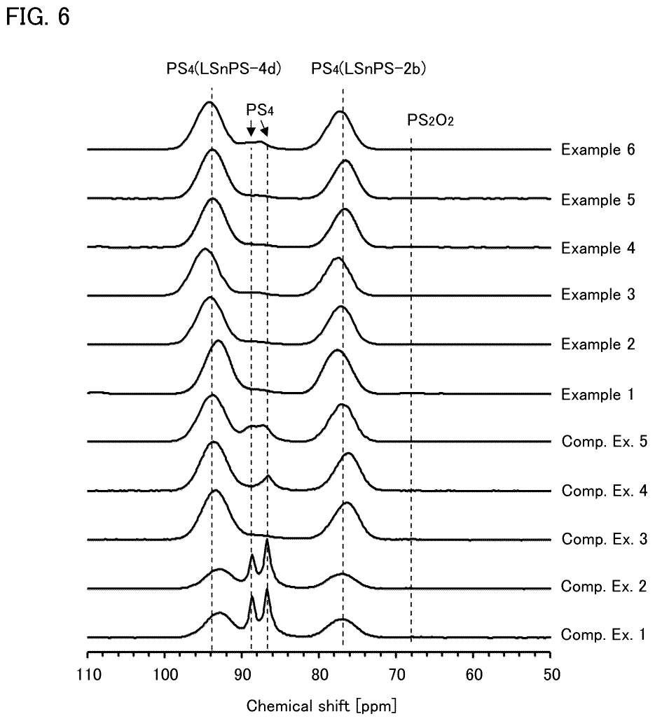

The results are shown in FIG. 6. As shown in FIG. 6, it was confirmed that all the sulfide solid electrolytes obtained in Examples 1 to 6 and Comparative Examples 1 to 5 had the LSnPS crystal phase. In specific, in these sulfide solid electrolytes, the first peak was observed around 77 ppm as the peak of the LSnPS crystal phase, which was the peak of PS₄ (LSnPS-2b, tetrahedron T₂ in FIG. 2). Also, in these sulfide solid electrolytes, the second peak was observed around 93 ppm as the peak of the LSnPS crystal phase, which was the peak of PS₄ (LSnPS-4d, tetrahedron T₁ in FIG. 2).

Also, in Comparative Examples 1 and 2, two peaks of PS₄ in a phase other than the LSnPS crystal phase were confirmed. These peaks correspond to the third peak and the fourth peak in FIG. 1B described above. These two peaks were presumably the peaks of PS₄ in Li₃PS₄. The third peak and the fourth peak were slightly confirmed also in Examples 1 to 6 and Comparative Examples 3 to 5.

As described above, in the XRD measurement, it was suggested that the sulfide solid electrolytes obtained in Examples 1 to 6 and Comparative Examples 3 to 5 were respectively the material including the LSnPS crystal phase as a single phase. In contrast, when precise measurement by ³¹P-NMR was performed, it was confirmed that the sulfide solid electrolytes obtained in Examples 1 to 6 and Comparative Examples 3 to 5 contained the impurity components to a small degree, other than the LSnPS crystal phase.

Also, as shown in FIG. 6, in all the sulfide solid electrolytes obtained in Examples 1 to 6 and Comparative Examples 1 to 5, the peak of PS₂O₂ was slightly confirmed. This peak corresponds to the fifth peak in FIG. 1B described above. Also, PS₂O₂ is a component containing oxygen that is inevitably included. Peak separation of the NMR chart obtained in Examples 1 to 6 and Comparative Examples 3 to 5 was respectively performed to obtain an area of each peak. The results are shown in Table 2.

TABLE 2

| | | NMR | | | | |
|---|---|---|---|---|---|---|
| | XRD | A: 93 ppm | B: 89 ppm | C: 87 ppm | D: 77 ppm | E: 68 ppm |
| Example 1 | LSnPS single phase | 53.2 | 0 | 3.2 | 42.2 | 0.3 |
| Example 2 | LSnPS single phase | 54.8 | 1 | 2 | 41.8 | 0.3 |
| Example 3 | LSnPS single phase | 55.1 | 0 | 3.3 | 40.5 | 0.4 |
| Example 4 | LSnPS single phase | 55.7 | 0 | 3.1 | 40.5 | 0.3 |
| Example 5 | LSnPS single phase | 56.2 | 0 | 3.2 | 40.1 | 0.5 |
| Example 6 | LSnPS single phase | 52.7 | 1.8 | 5.6 | 39.6 | 0.3 |
| Comp. Ex. 1 | LSnPS + Li₄SnS₄ | 33.4 | 19.1 | 19.9 | 26.5 | 0.6 |
| Comp. Ex. 2 | LSnPS + Li₄SnS₄ | 30.0 | 19.3 | 25.5 | 24 | 0.6 |
| Comp. Ex. 3 | LSnPS single phase | 52.5 | 0 | 6.8 | 39.4 | 0.8 |
| Comp. Ex. 4 | LSnPS single phase | 50.9 | 0 | 10.8 | 37 | 0.9 |
| Comp. Ex. 5 | LSnPS single phase | 48.6 | 4.8 | 10 | 36.3 | 0.2 |

Also, in each Example and each Comparative Example, the total area of the first to the fifth peaks was obtained, and determined as S₁ (S₁=A+B+C+D+E). Also, the total area of the first peak and the second peak was obtained and determined as S₂ (S₂=A+D). Also, the total area of the third peak and the fourth peak was obtained, and determined as S₃ (S₃=B+C). Also, the area of the fifth peak was determined as S₄ (S₄=E). From these results, S₂/S₁, S₃/S₁, S₄/S₁, and S₄/S₂ were respectively obtained. The results are shown in Table 3.

### <Ion Conductivity Measurement>

The ion conductivity of the sulfide solid electrolytes obtained in Examples 1 to 6 and Comparative Examples 1 to 5 was respectively measured. First, the sulfide solid electrolyte was weighted to be 200 mg, put in a cylinder made of macole, and pressed by the pressure of 4 ton/cm². Both ends of the obtained pellet was sandwiched by a pin made of SUS, and a restraining pressure was applied to the pellet by bolting. The ion conductivity was calculated by A.C. impedance method while the obtained sample was maintained at 25° C. In the measurement, Solartron1260 was used, with the applied voltage of 5 mV and the measurement frequency range of 0.01 to 1 MHZ. The results are shown in Table 3.

TABLE 3

| | | | | | Ion |
|---|---|---|---|---|---|
| | S₂/S₁ | S₃/S₁ | S₄/S₁ | S₄/S₂ | conductivity |
| | (%) | (%) | (%) | (%) | (mS/cm) |
| Example 1 | 96.5 | 3.24 | 0.30 | 0.31 | 5.1 |
| Example 2 | 96.6 | 3.00 | 0.30 | 0.31 | 5.4 |
| Example 3 | 95.6 | 3.32 | 0.40 | 0.42 | 5.4 |
| Example 4 | 96.2 | 3.11 | 0.30 | 0.31 | 5.5 |
| Example 5 | 96.3 | 3.20 | 0.50 | 0.52 | 5.3 |
| Example 6 | 92.3 | 7.40 | 0.30 | 0.33 | 5.3 |
| Comp. Ex. 1 | 59.9 | 39.20 | 0.60 | 1.00 | 3.9 |
| Comp. Ex. 2 | 54.0 | 45.07 | 0.60 | 1.11 | 4.4 |
| Comp. Ex. 3 | 91.9 | 6.83 | 0.80 | 0.87 | 4.8 |
| Comp. Ex. 4 | 87.9 | 10.84 | 0.90 | 1.02 | 4.2 |
| Comp. Ex. 5 | 84.9 | 14.81 | 0.20 | 0.24 | 4.4 |

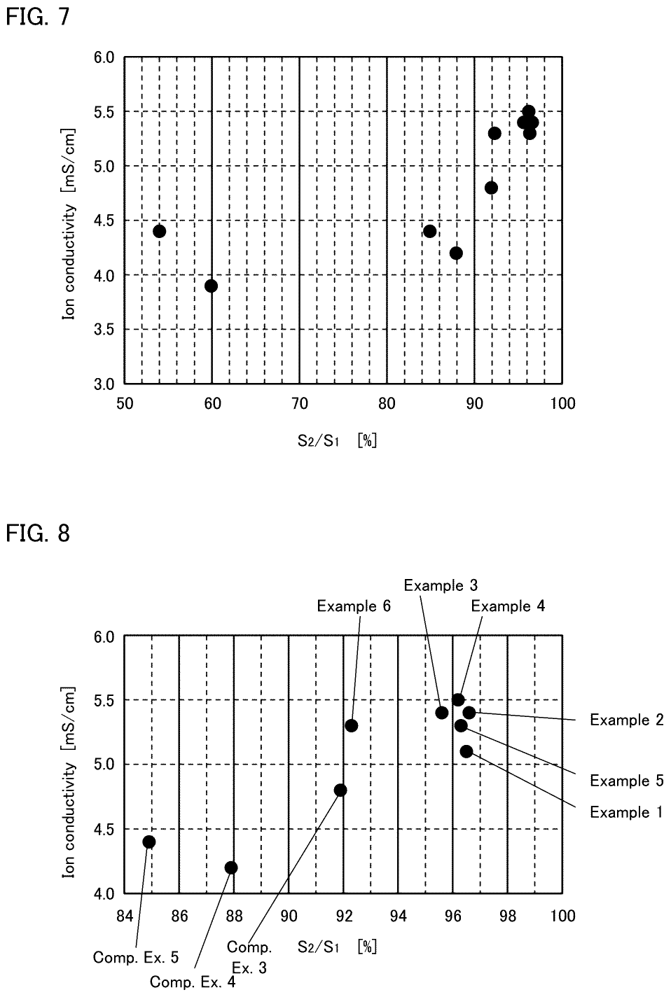

As shown in Table 3, the S₂/S₁ of Examples 1 to 6 was respectively larger than that of Comparative Examples 1 to 5, and the ion conductivity was also higher. This was presumably because the sulfide solid electrolytes obtained in Examples 1 to 6 contained remarkably a lot of the LSnPS crystal phase. Here, FIG. 7 is a graph showing the relation of the ratio of the LSnPS crystal phase and the ion conductivity regarding the sulfide solid electrolytes obtained in Examples 1 to 6 and Comparative Examples 1 to 5. Also, FIG. 8 is an enlarged view of a part of FIG. 7. As shown in FIG. 7 and FIG. 8, when the S₂/S₁ was 92.0% or more, the ion conductivity clearly improved. In Examples 1 to 6, the reasons why the S₂/S₁ was large and why the S₃/S₁ was small were presumably because Li₃PS₄ that was impurity component was removed by heating in the inert gas flow. Also, it was presumed that the ion conductivity improved since Li₃PS₄ was removed and the ratio of the LSnPS crystal phase relatively increased. Also, as shown in Table 3, the S₄/S₁ and the S₄/S₂ in Examples 1 to 6 were respectively smaller than those of Comparative Examples 1 to 5. The reasons therefor were presumably because Li₃PS₂O₂ that was impurity component was removed by heating in the inert gas flow. It was presumed that the ion conductivity improved since Li₃P₂O₂ was removed and the ratio of the LSnPS crystal phase relatively increased.

### REFERENCE SIGNS LIST

1 cathode layer
2 anode layer
3 electrolyte layer
4 cathode current collector
5 anode current collector
6 outer package
10 battery

What is claimed is:

1. A vehicle comprising a battery,
the battery includes a cathode layer containing a cathode active material, an anode layer containing an anode active material, and an electrolyte layer arranged between the cathode layer and the anode layer,
at least one of the cathode layer, the anode layer, and the electrolyte layer contains a sulfide solid electrolyte,
the sulfide solid electrolyte comprises a LGPS-type crystal phase containing a Li element, a Sn element, a P element, and a S element, wherein:
the sulfide solid electrolyte has a composition represented by Li₄₋ₓSn₁₋ₓPₓS₄, provided that 0.67<x<0.76;
the sulfide solid electrolyte includes, in a ³¹P-NMR measurement, a first peak of which peak position is 77 ppm±1 ppm, and a second peak of which peak position is 93 ppm±1 ppm; and
when S₁ designates a total area of all peaks obtained in the ³¹P-NMR measurement, and S₂ designates a total area of the first peak and the second peak, a rate of S₂ with respect to S₁, which is S₂/S₁ is 92.0% or more.

2. The vehicle according to claim 1, wherein:
the sulfide solid electrolyte includes at least one of a third peak of which peak position is 87 ppm±1 ppm, and a fourth peak of which peak position is 89 ppm±1 ppm, in a ³¹P-NMR measurement; and
when S₁ designates a total area of all peaks obtained in the ³¹P-NMR measurement, and S₃ designates a total area of the third peak and the fourth peak, a rate of S₃ with respect to S₁, which is S₃/S₁ is 6.0% or less.

3. The vehicle according to claim 1, wherein:
the sulfide solid electrolyte includes a fifth peak of which peak position is 68 ppm±1 ppm in a ³¹P-NMR measurement; and
when S₁ designates an area of all peaks obtained in the ³¹P-NMR measurement, and S₄ designates an area of the fifth peak, a rate of S₄ with respect to S₁, which is S₄/S₁ is 0.5% or less.

4. The vehicle according to claim 1, wherein the S₂/S₁ is 95.0% or more.

5. The vehicle according to claim 1, wherein the x satisfies 0.67<x≤0.74.

6. The vehicle according to claim 1, wherein the x satisfies 0.67<x≤0.72.

7. The vehicle according to claim 1, wherein an ion conductivity of the sulfide solid electrolyte at 25° C. is 5.25 mS/cm or more.
